(19) United States
(12) Patent Application Publication
(10) Pub. No.: US 2024/0228091 A1
(43) Pub. Date: Jul. 11, 2024

(54) PRE-STRETCH FILM AND ITS METHOD OF PRODUCTION

(71) Applicant: Alliance Plastics, LLC, Rock Hill, SC (US)

(72) Inventor: Troy Wolf, Depere, WI (US)

(73) Assignee: Alliance Plastics, LLC, Rock Hill, SC (US)

(21) Appl. No.: 18/151,425

(22) Filed: Jan. 7, 2023

(51) Int. Cl. B65B 41/16; B29C 55/18; B65B 11/02

(52) U.S. Cl. CPC B65B 41/16; B29C 55/18; B65B 11/02; B65B 2011/002

(57) ABSTRACT

An apparatus for fabricating a reinforced stretch film comprising a plurality of edge folding stations, each folding stations being configured to fold each edge of the stretch film one time, a plurality of drums for stretching the stretch film downstream of the plurality of edge folding stations, the drums being configured to rotate with different surface speeds to pre-stretch the stretch film, a final roller for winding the pre-stretched stretch film, and an assembly for driving the final roller.

### FIELD OF INVENTION

The instant invention relates to a method for producing plastic film, more particularly reinforced stretch film or plastic films used for stretch wrapping, and even more particularly, reinforced stretch film employed in pallet wrapping and other applications. The invention also encompasses the reinforced stretch film.

### BACKGROUND OF THE INVENTION

Stretch films are well known and such films are commonly employed, for example, to wrap goods and products of various types positioned on a pallet, the film wholly or partially covering the goods or products and also typically applied to the pallet itself to secure the pallet to the items positioned thereon. The films themselves are typically made of polyethylene, although other stretch film sheet materials can be employed as well.

To reduce packaging costs, it may be desired to use as little stretch film as possible. In addition, to reduce shipping costs by keeping the shipping weight as low as possible and minimizing the space required for shipping, it may be desired for the film to be as light weight and as thin as possible. However, for obvious safety concerns of both the product being shipped and the humans and equipment used in shipping, stretch films need to have high strength. These problems are all interrelated as typically the less film you use, or the lighter and thinner the stretch film is, the less strength it will have. This is especially true for heavier loads (like bricks, cement blocks, bags, drums, steel tubes, pipes etc.) where stretch films are being continuously wrapped around the pallets to achieve load retention. Currently, the safety concerns are strong enough that the stretch film has to be wrapped with heavier gauge material, like straps, bags or stretch hoods, or an immense amount of film with low pre-stretch is used to keep the heavy product secure. However, both of these options clearly increase packaging and/or shipping costs.

Thus, there is clearly a need to create a lightweight thin stretch film that has high strength and can create a high force to load ratio. The instant invention is designed to provide a reinforced stretch film that addresses at least some of the above-mentioned problems.

### SUMMARY

An apparatus for fabricating a reinforced stretch film comprising a plurality of edge folding stations, each folding stations being configured to fold each edge of the stretch film one time, a plurality of drums for stretching the stretch film downstream of the plurality of edge folding stations, the drums being configured to rotate with different surface speeds to pre-stretch the stretch film, a final roller for winding the pre-stretched stretch film, and an assembly for driving the final roller.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a side view of one embodiment of the apparatus for the production of the roll of reinforced stretch film of the instant invention.

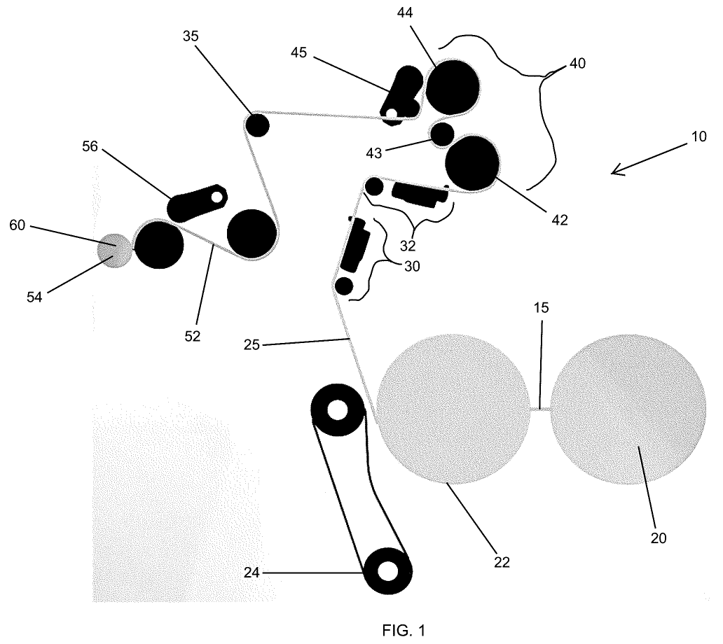

FIG. 2 is a side view of one embodiment of the apparatus for the production of the roll of reinforced stretch film of the instant invention.

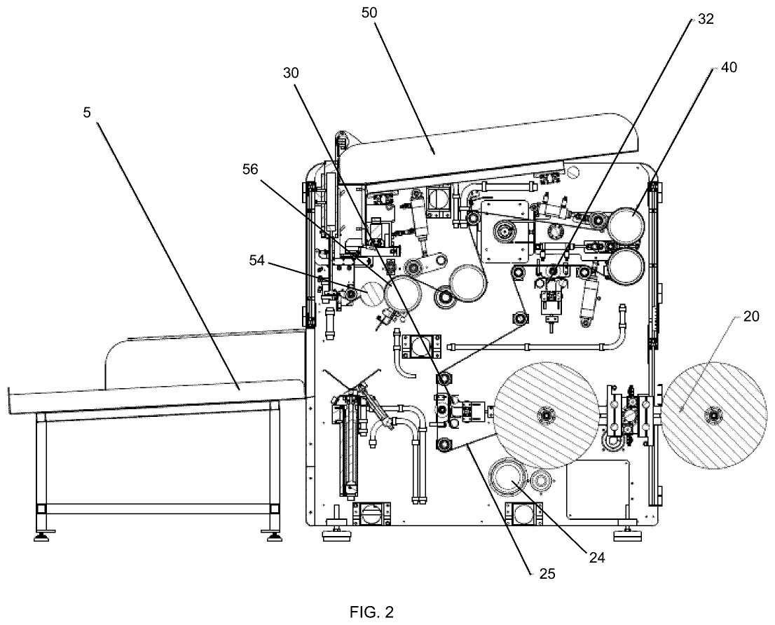

FIG. 3 is a perspective view illustrating the film being folded a first time running through the first edge folding station and being folded a second time running through the second edge folding station.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Reinforced stretch film 60 may be used for wrapping heavy materials onto a pallet. The heavy material may be any material desired to be wrapped on pallet, including, but not limited to, heavier pallet materials like bricks, cement blocks, bags, drums, steel tubes, pipes, other similar materials, etc. Reinforced stretch film 1 may provide a high strength, tear resistant stretch film that is capable of securing such heavy materials onto pallet. Reinforced stretch film 60 may allow a user to wrap such heavy materials onto pallet safely and securely with less material, weight and space without the need for heavier gauge material, like straps, bags or stretch hoods, or an immense amount of film. Reinforced stretch film 60 may generally be comprised of a base sheet of plastic film 15. The instant invention includes an apparatus 10 for fabricating a reinforced stretch film 60 comprising a plurality of edge folding stations 30, 32, each folding station being configured to fold each edge of a stretch film 15 one time, a plurality of drums 42, 44 for stretching the stretch film downstream of the plurality of edge folding stations, the drums being configured to rotate with different surface speeds to pre-stretch the stretch film, a final roller 54 for winding the reinforced stretch film 60, and an assembly 56 for driving the final roller 54. A hopper 50 is used to store cores on which the final reinforced stretch film is collected.

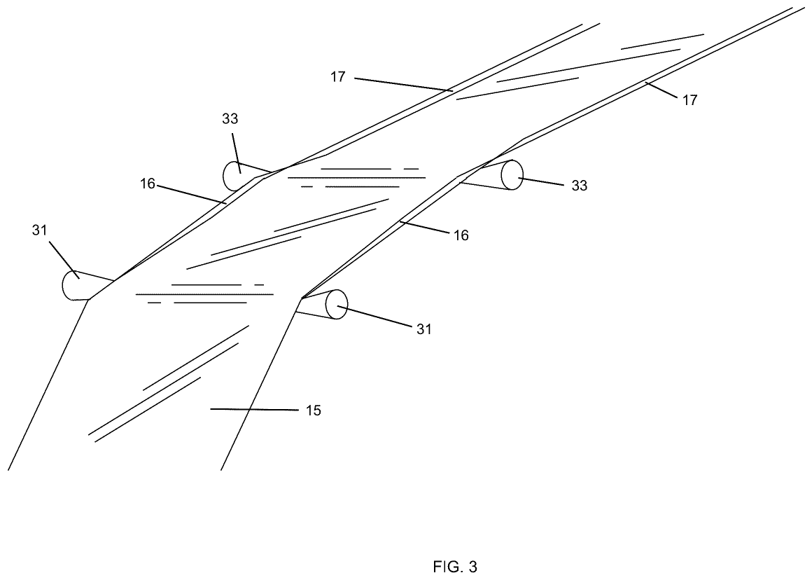

The film 15 which is fed into the apparatus 10 includes an elongated base sheet which has a longitudinal axis and be made of any suitable material for a stretch film, including any suitable plastic stretch films such as a polyethylene material, including, but not limited to linear low-density polyethylene, also known as LLDP. The film 15 includes a pair of sides which engage the folding edge stations discussed previously. The apparatus 10 can further include a first edge folding station 30 having a pair of folding members 31 which engage each outer edge of the stretch film 15, folding each edge inward a first time, resulting in a single folded edge 16 stretch film and a second edge folding station 32 having a pair of folding members 33 which engage each outer edge of the single fold 16 stretch film, folding each edge inward a second time, resulting in a double folded edge 17 stretch film. Each of the folding members 31, 33 can be any shape to facilitate the folding of the outer edge of the stretch film 15 including being conically shaped (FIG. 3).

Looking now to the Figures, there is illustrated an apparatus 10 which includes an elongated base sheet of plastic stretch film 15 fed into the apparatus from an unwinding unit 20. The film 15 then moves downstream to the staging unit 22 which may be driven by a first assembly 24. The film then follows the film path 25 to the first edge folding station 30 where each edge engages a folding member 31 where each side edge of the elongated base sheet of plastic stretch film is folded inward along the lateral direction a first time creating a single folded edge 16 to further strengthen and reinforce each side edge. The film continues downstream to a second edge folding station 32 where each single folded edge 16 engages a folding member 33 where each edge of the elongated base sheet of plastic stretch film is folded inward along the lateral direction a second time creating a double folded edge 17 to further strengthen and reinforce each side edge. The film continues downstream to a pre-stretch unit 40 which includes a first drum 42 and a first drum counter-roller 43 and optionally includes a second drum 44 and a second drum counter-roller 44. The film passes between the first drum 42 and a first drum counter-roller 43, and optionally the second drum 44 and a second drum counter-roller 44 in which the level of pre-stretch is adjusted by altering the transmission ratio of two or more power transmission gears operationally associated with the first drum 42 and the first drum counter-roller 43, and optionally the second drum 44 and the second drum counter-roller 44, wherein the level of pre-stretch is achieved by passing the film over the drums while set at a desired gear ratio creating a pre-stretched, double-folded edge film or reinforced stretch film 60. The film continues downstream, being guided by guiding rollers 35 along a loading path 52. The film 60 is then collected on a core operationally associated with a final rolling unit 54 and sent to an unloading table. The film may be drawn through the apparatus by a second assembly 56.

The instant invention includes a reinforced stretch film 60 comprising an elongated base sheet of plastic stretch film 15 having a longitudinal axis and two side edges, where each side edge of the elongated base sheet of plastic stretch film is folded inward along the lateral direction a first time creating a single folded edge 16 to further strengthen and reinforce each side edge, and where each single folded edge 16 is folded inward along the lateral direction a second time creating a double folded edge 17 to further strengthen and reinforce each side edge of the reinforced stretch film. The apparatus creates a reinforced stretch film 60 which is stretched along its length. In one embodiment, the reinforced stretched film 60 is stretched along the length thereof between 50% and 300% of the original length of the stretch film. The reinforced stretch film 60 is rolled around a core. The reinforced stretch film 60 has increased strength characteristics due to stretching and folded edges. The reinforced stretch film 60 is stretched to impart a memory to the reinforced stretch film to permit contraction of the reinforced stretch film when unwound to wrap a pallet load.

The instant invention also includes a method of producing a reinforced stretch film 60 comprising the steps of:

(a) providing an elongated base sheet of plastic stretch film 15 having a longitudinal axis and two side edges;

(b) feeding the elongated base sheet of plastic film 15 into an apparatus to a first edge folding station 30 where each side edge of the elongated base sheet of plastic stretch film is folded inward along the lateral direction a first time creating a single folded edge 16 to further strengthen and reinforce each side edge;

(c) feeding the elongated base sheet of plastic film into a second edge folding station 32 where each folded edge of the elongated base sheet of plastic stretch film is folded inward along the lateral direction a second time creating a double folded edge 17 to further strengthen and reinforce each side edge;

(d) feeding the elongated base sheet into a pre-stretch unit 40 in which the level of pre-stretch is adjusted by altering the transmission ratio of two or more power transmission gears operationally associated with a first drum 42 and a first drum counter-roller 43, and optionally a second drum 44 and a second drum counter-roller 44, wherein the level of pre-stretch is achieved by passing the film over the drums while set at a desired gear ratio creating a pre-stretched, double-folded edge film or reinforced stretch film 60; and

(e) collecting the reinforced stretch film 60 on a core

The method above can include the first edge folding station 30 having a pair of folding members 31 which engage each outer edge of the stretch film, folding each edge inward a first time, resulting in a single folded edge 16 stretch film and the second edge folding station 32 having a pair of folding members 33 which engage each outer edge of the single fold stretch film, folding each edge inward a second time, resulting in a double folded edge 17 stretch film.

Any method described herein may incorporate any design element contained within this application and any other document/application incorporated by reference herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present invention may be embodied in other forms without departing from the spirit and the essential attributes thereof, and, accordingly, reference should be made to the appended claims, rather than to the foregoing specification, as indicating the scope of the invention. The invention illustratively disclosed herein suitably may be practiced in the absence of any element which is not specifically disclosed herein.

1. An apparatus for fabricating a reinforced stretch film comprising:
a plurality of edge folding stations, each folding station being configured to fold each edge of a stretch film one time;
a plurality of drums for stretching the stretch film downstream of the plurality of edge folding stations, the drums being configured to rotate with different surface speeds to pre-stretch the stretch film;
a final roller for winding the reinforced stretch film; and
an assembly for driving the final roller.

2. The apparatus of claim 1 including;
a first edge folding station having a pair of folding members which engage each outer edge of the stretch film, folding each edge inward a first time, resulting in a single folded edge stretch film; and
a second edge folding station having a pair of folding members which engage each outer edge of the single fold stretch film, folding each edge inward a second time, resulting in a double folded edge stretch film.

3. The apparatus of claim 2 wherein each of the folding members is conically shaped.

4. The apparatus of claim 1 wherein the reinforced stretch film is stretched along its length.

5. The apparatus of claim 1 wherein the reinforced stretch film is rolled around a core.

6. The apparatus of claim 1 wherein the reinforced stretch film has increased strength characteristics due to stretching and folded edges.

7. The apparatus of claim 1 wherein the reinforced stretch film is stretched to impart a memory to the reinforced stretch film to permit contraction of the reinforced stretch film when unwound to wrap a pallet load.

8. A reinforced stretch film comprising:
an elongated base sheet of plastic stretch film having a longitudinal axis and two side edges;
where each side edge of the elongated base sheet of plastic stretch film is folded inward along the lateral direction a first time creating a single folded edge to further strengthen and reinforce each side edge; and
where each single folded edge is folded inward along the lateral direction a second time creating a double folded edge to further strengthen and reinforce each side edge of the reinforced stretch film.

9. The reinforced stretch film of claim 8 wherein the reinforced stretch film is stretched along its length.

10. The reinforced stretch film of claim 9 wherein the reinforced stretched film is stretched along the length thereof between 50% and 300% of the original length of the stretch film.

11. The reinforced stretch film of claim 8 wherein the reinforced stretch film is rolled around a core.

12. The reinforced stretch film of claim 8 wherein the reinforced stretch film has increased strength characteristics due to stretching and folded edges.

13. The reinforced stretch film of claim 8 wherein the reinforced stretch film is stretched to impart a memory to the reinforced stretch film to permit contraction of the reinforced stretch film when unwound to wrap a pallet load.

14. A method of producing a reinforced stretch film comprising the steps of:
providing an elongated base sheet of plastic stretch film having a longitudinal axis and two side edges;
feeding the elongated base sheet of plastic film into a first edge folding station where each side edge of the elongated base sheet of plastic stretch film is folded inward along the lateral direction a first time creating a single folded edge to further strengthen and reinforce each side edge;
feeding the elongated base sheet of plastic film into a second edge folding station where each folded edge of the elongated base sheet of plastic stretch film is folded inward along the lateral direction a second time creating a double folded edge to further strengthen and reinforce each side edge;
feeding the elongated base sheet into a pre-stretch unit in which the level of pre-stretch is adjusted by altering the transmission ratio of two or more power transmission gears operationally associated with a first drum and a first drum counter-roller, wherein the level of pre-stretch is achieved by passing the materials over the drums while set at a desired gear ratio creating a pre-stretched, double-folded edge film or reinforced stretch film; and
collecting the reinforced stretch film on a core.

15. The method of claim 14 wherein
the first edge folding station having a pair of folding members which engage each outer edge of the stretch film, folding each edge inward a first time, resulting in a single folded edge stretch film; and
the second edge folding station having a pair of folding members which engage each outer edge of the single fold stretch film, folding each edge inward a second time, resulting in a double folded edge stretch film.

16. The method of claim 14 wherein the reinforced stretch film is stretched along its length.

17. The method of claim 14 wherein the reinforced stretched film is stretched along the length thereof between 50% and 300% of the original length of the stretch film.

18. The method of claim 14 wherein the reinforced stretch film is rolled around a core.

19. The method of claim 14 wherein the reinforced stretch film has increased strength characteristics due to stretching and folded edges.

20. The method of claim 14 wherein the reinforced stretch film is stretched to impart a memory to the reinforced stretch film to permit contraction of the reinforced stretch film when unwound to wrap a pallet load.
